(19) United States
(12) Patent Application Publication
(10) Pub. No.: US 2008/0166528 A1
(43) Pub. Date: Jul. 10, 2008

(54) Method and Apparatus for Manufacturing an Optical Component

(75) Inventors: Gary Fairless Power, Victoria (AU); Paul Henson, Victoria (AU); John Grace, New South Wales (AU); Roderick Andrew, Taisnieres s/Hon (FR)

Correspondence Address: BARNES & THORNBURG LLP, 750-17TH STREET NW, SUITE 900, WASHINGTON, DC, 20006-4675, US

(73) Assignee: SECURENCY PTY LIMITED, Craigieburn, Victoria (AU)

(21) Appl. No.: 10/597,737

(22) PCT Filed: Feb. 4, 2005
(86) PCT No.: PCT/AU05/00145

§ 371 Date: Dec. 10, 2007

(30) Foreign Application Priority Data
Feb. 5, 2004 (AU) 2004900553

(51) Int. Cl. B29D 11/00; B32B 3/00; G03B 27/72

(52) U.S. Cl. 428/195.1; 264/1.37; 355/71

(57) ABSTRACT

A method and apparatus for manufacturing an optical component having at least one photo-oriented polymeric layer is provided. The apparatus includes a single source of laser radiation, beam splitting means for splitting the laser radiation into a first beam of linearly polarized light having a first plane of polarization (P) and a second beam of linearly polarized light having a second plane of polarization (S), first directing means for directing the first beam of linearly polarized light onto a first area or areas of at least one photo-orientatable polymeric layer to cause a first molecular orientation in said first area or areas of the layer and second directing means for directing the second beam of linearly polarized light onto said photo-orientatable polymeric layer to cause a second molecular orientation in a second area or areas of the layer. The apparatus includes delay means for the second beam of linearly polarized light so that the second beam arrives at the photo-orientatable polymeric layer a predetermined delay time after the first beam of linearly polarized light.

This invention relates to optical components having at least one photo-oriented polymeric layer and is particularly concerned with a method and apparatus for manufacturing such a component.

U.S. Pat. No. 5,389,698 discloses a process for making oriented polymers in which a layer of photo-polymerisable optically isotropic polymeric material is irradiated by linearly polarised light to orientate and polymerise the molecules in the layer to obtain the oriented photopolymer.

Oriented photopolymers can be used in a variety of optical and electro optical devices, such as in the manufacture of liquid crystal cells. It has also been proposed that oriented photopolymers may form part of multi-layer optical components which can be used as a safeguard against counterfeiting and copying. U.S. Pat. No. 6,160,597 discloses such a multi-layer optical component and a method of manufacture which has at least one photo-oriented polymeric layer applied to a substrate, and a layer of non-cross linked liquid crystalline monomer is applied onto the photo-oriented layer with its molecules having the orientation of the underlying photo-oriented layer, and then the monomer is cross-linked to form a liquid crystalline polymer in which the orientation of the molecules is fixed. Such an optical component may also include additional layers, such as further orientating layers and liquid crystal layers, an optical retarder, and reflective or polarising layers to form more complex multi-layer structures.

It is also possible, in the processes disclosed in U.S. Pat. No. 5,389,698 and U.S. Pat. No. 6,160,597 for a photo-oriented polymeric layer to have an orientation pattern including a first region having a first molecular orientation and at least one other region having a second molecular orientation. This is achieved in the process of U.S. Pat. No. 5,389,698 by two successive illumination stages using a first source of linearly polarised light in the first illumination stage to irradiate a first region or regions through a mask, and then using a second source of linearly polarised light having a different plane of polarisation in the second illumination stage with the mask removed. However, this multiple exposure process can be inefficient and time consuming because of the time required to remove the mask, replace the first source of linearly polarised light with the second source and reconfigure the apparatus. It is therefore desirable to provide a more efficient method of manufacturing an optical component having at least one photo-oriented polymeric layer with an orientation pattern that includes different regions of different molecular orientation. It is also desirable to provide an apparatus for use in such a method.

According to one aspect of the invention, there is provided a method of manufacturing an optical component having at least one photo-oriented polymeric layer provided on a substrate, wherein the method includes the steps of:

providing a single source of laser radiation;

splitting the laser radiation into a first beam of linearly polarised light having a first plane of polarisation, and a second beam of linearly polarised light having a second plane of polarisation;

directing the first beam of linearly polarised light onto a first area or areas of at least one photo-orientatable polymeric layer to cause a first molecular orientation in the first area or areas of the layer; and

directing the second beam of linearly polarised light onto said photo-orientatable polymeric layer to cause a second molecular orientation in a second area or areas of the layer.

Preferably the arrangement is such that the second beam of linearly polarised light arrives at the photo-orientatable polymeric layer a predetermined delay time after the first beam of linearly polarised light. The predetermined delay time is preferably sufficient for the first beam to have caused the first molecular orientation in the first area or areas of the photo-orientatable polymeric layer before the second beam arrives.

According to a second aspect of the invention, there is provided an apparatus for manufacturing an optical component having at least one photo-oriented polymeric layer, wherein the apparatus comprises:

a single source of laser radiation;

beam splitting means for splitting the laser radiation into a first beam of linearly polarised light having a first plane of polarisation and a second beam of linearly polarised light having a second plane of polarisation;

first directing means for directing the first beam of linearly polarised light onto a first area or areas of at least one photo-orientatable polymeric layer to cause a first molecular orientation in said first area or areas of the layer; and

second directing means for directing the second beam of linearly polarised light onto said photo-orientatable polymeric layer to cause a second molecular orientation in a second area or areas of the layer;

wherein the apparatus includes delay means for the second beam of linearly polarised light so that the second beam arrives at the photo-orientatable polymeric layer a predetermined delay time after the first beam of linearly polarised light.

The second beam of linearly polarised light is preferably reflected off a plurality of mirrors before it is directed onto the photo-orientatable polymeric layer.

In one preferred embodiment, the first beam of linearly polarised light is directed onto the photo-orientatable polymeric layer through a mask so that only the first area or areas of the photo-orientatable polymeric layer are exposed to the first beam. The second beam of linearly polarised light may be directed onto the second area or areas, e.g. through another mask. Preferably, however, the second beam is directed onto the entire area of the photo-orientatable polymeric layer including the first and second areas. In this case, because the second beam arrives at the photo orientatable polymeric layer at a predetermined delay time after the first beam of linearly polarised light, the first beam has already orientated and polymerised the molecules in the first area or areas of the layer to fix the orientation in the first area or areas before the second beam arrives. Then the second beam only orientates and polymerises the molecules in the second area or areas without affecting the orientation of the molecules in the first area or areas.

Preferably, the predetermined delay time is in the order of nanoseconds which is sufficient time for the first beam to orientate and polymerise the molecules in the first area or areas of the layer.

Preferably, the energy of each of the first and second beams is less than the energy required to cause laser ablation of the photo-orientatable polymeric layer, and also less than the cohesive/adhesive forces adhering the photo-orientatable polymeric layer to the underlying layer, which may be the substrate itself or an intermediate layer, such as a primer, or other layer.

Preferably, the ratio of the energy of the first beam and the energy of the second beam is approximately 2:1 energy units.

In one preferred embodiment, the substrate is formed from a polymeric material. Preferably, the substrate includes at least one layer of biaxially oriented polymeric material. For example, the substrate may comprise a base layer of at least two films of transparent biaxially oriented polymeric material laminated together, such as described in WO 83/00659. The substrate may also include one or more co-polymer layers on one or both sides of the base layer of biaxially oriented polymeric material. Alternatively, the substrate may be formed from other materials, for example, a glass plate or a paper sheet. Another alternative is for the substrate to comprise a base layer of paper with at least one polymeric layer, e.g. a co-polymer, provided on one or both sides of the base layer.

The substrate may also include at least one opacifying coating applied on at least one side of the base layer, particularly when the base layer is formed from a transparent polymeric material. The at least one opacifying coating may completely cover the surface of the transparent substrate. Alternatively, the at least one opacifying coating may only partially cover the transparent substrate so as to form a transparent portion or window which is not covered by the opacifying coating.

Preferably, an optical component formed by the method of the invention includes at least one liquid crystal polymer (LCP) layer in contact with the photo oriented polymeric layer, otherwise called a photo-alignment layer. The photo alignment layer is preferably a photo-oriented polymer network (PPN) such as described in U.S. Pat. No. 5,602,661, the contents of which are incorporated herein by reference. The LCP layer has an arrangement of molecules having an orientation determined by the orientation of the underlying photo-alignment (PPN) layer or transferred therefrom to the LCP layer. The LCP layer may be photo crosslinked by the action of light of a suitable wavelength and retains the orientation of molecules determined by the orientating layer. The photo cross-linking fixes the orientation of the LCP layer so that it is unaffected by extreme external influences such as light or high temperatures.

The security document or device may include further orientating layers and/or LCP layers. For example, two or more orientating layers and LCP layers having different orientation patterns may be provided to form a stack of orientation layers and LCP layers on a substrate as disclosed in U.S. Pat. Nos. 5,602,661 and 6,160,597, the contents of which are incorporated herein by reference.

The security document or device may also include other layers, such as a reflector layer or a polarising layer. For example, U.S. Pat. No. 6,144,428 discloses a reflective metal layer between the photo-alignment layer and the substrate, and WO 98/52077 discloses a linear polariser between the orientation layer and the substrate. If the security document or device includes a reflector or a linear polariser, the optical effects produced by the LCP layer and orientating layer in combination may be viewed using a single polariser, instead of requiring cross polarisers to view the effects.

The optical component formed by the combination of the LCP layer(s) and photo-alignment layer(s) may contain two or more hidden images, such as described in WO 00/29878. These images may be successively revealed and concealed when the optical component is held between two polarisers and one of them is rotated.

According to another aspect of the invention, there is provided an optical component which incorporates at least one photo-oriented polymeric layer formed by the method or apparatus of the first or second aspects of the invention.

Preferred forms of the present invention will now be described, by way of example only, with reference to the accompanying drawings, in which:

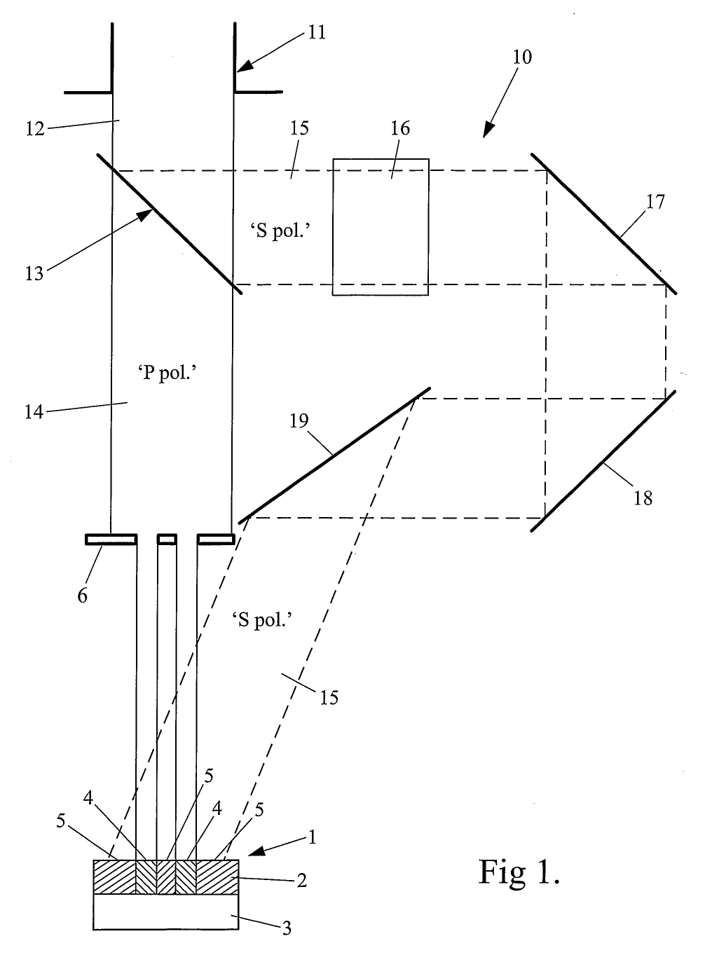

FIG. 1 is a schematic diagram illustrating a method and apparatus in accordance with the invention for manufacturing an optical component;

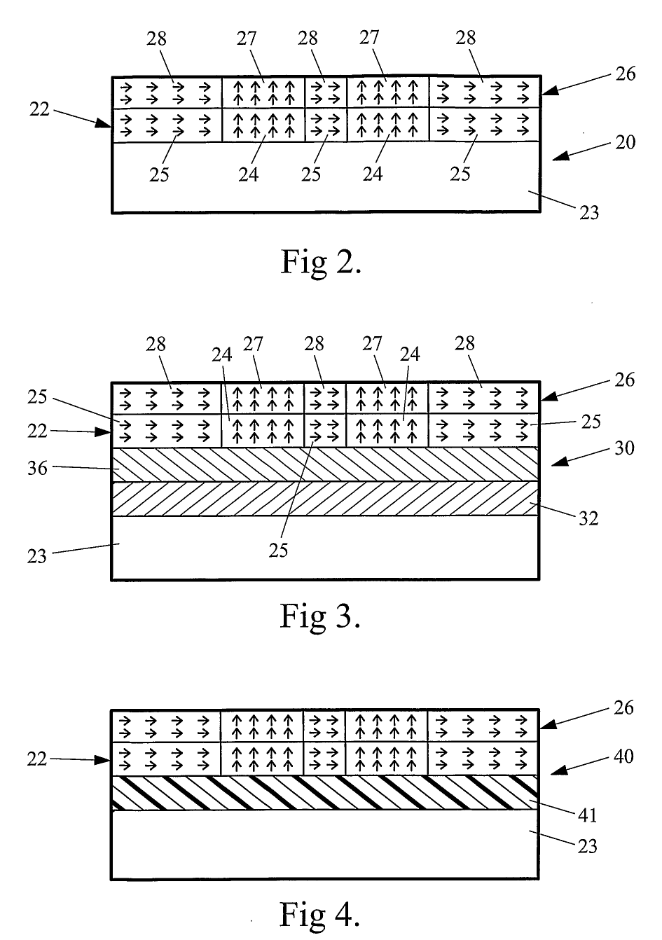

FIG. 2 is a schematic sectional view of an optical component produced by the method and apparatus of FIG. 1;

FIG. 3 is a schematic sectional view of a modified embodiment of an optical component;

FIG. 4 is a schematic sectional view of another modified embodiment of an optical component; and

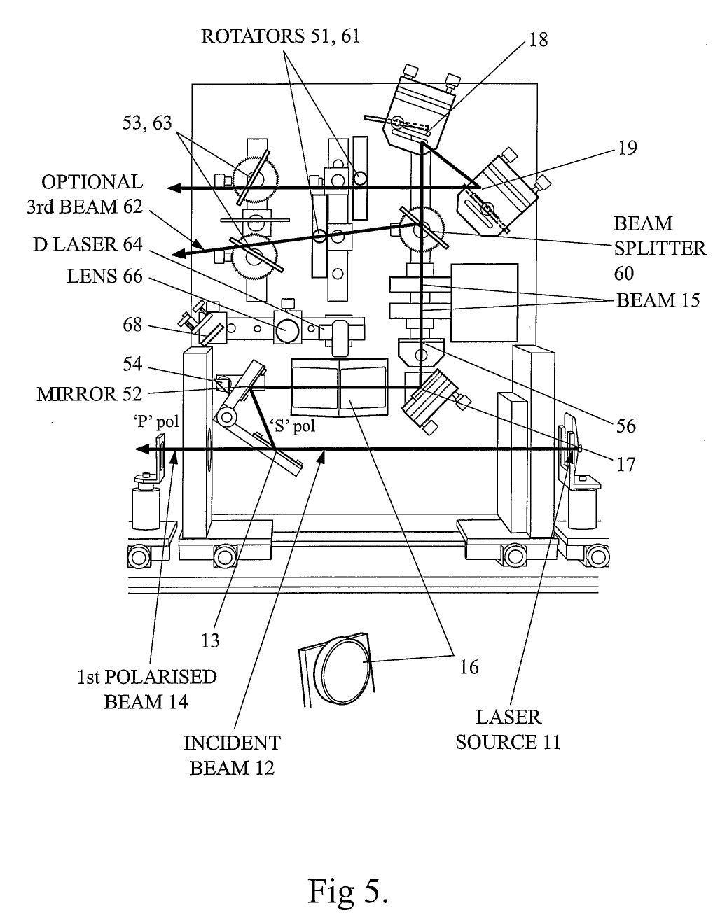

FIG. 5 is a plan view of part of the apparatus of FIG. 1.

FIG. 1 shows an apparatus 10 for manufacturing an optical component 1 which has a photo-orientatable polymeric layer 2, which preferably comprises a photo-orientable polymer network (PPN), provided on a substrate 3. The apparatus 10 comprises a laser source 11 which produces an incident beam 12 of laser radiation, a polarising beam splitter 13 which splits the laser radiation into a first beam 14 of linearly polarised light having a first plane of polarisation (P polarisation) and a second beam 15 of linearly polarised light having a second plane of polarisation (S polarisation). The first polarised beam 14 proceeds directly to the optical component 1 after passing through a mask 6 so that first areas 4 of the photo-orientatable polymeric layer 2 are illuminated by the first beam 14. The first beam 14 of linearly polarised light “P pol” orientates and polymerises the molecules in the first areas 4 of the photo-orientatable polymeric layer so that they have a first molecular orientation.

The second polarised laser beam 15 passes through a series of time of flight or delay mirrors 16 and is then reflected off directional reflection mirrors 17, 18 and 19 onto the photo-orientatable polymeric layer 2 of the optical component 1.

The second beam 15 of linearly polarised light “S pol” is directed onto the optical component to illuminate the surface of the photo-orientatable polymeric layer 2 to orientate and polymerise the molecules in second areas 5 of the layer 2 so that they have a second molecular orientation which is different from the orientation of the molecules in the first areas 4 of the layer. Although the first areas 4 of the photo-orientatable polymer layer 2 are also illuminated by the second beam of linearly polarised light, the second beam 15 arrives at the optical component 1 a predetermined delay time after the first beam 14 of linearly polarised light. This delay time is sufficient for the first beam 14 to have caused the first molecular orientation and polymerisation in first areas of the layer 2 before the second beam arrives.

The first and second areas 4 and 5 of different molecular orientations together form an orientation pattern in the photo-orientable layer 2 which is determined by the mask 6. The mask 6 may be formed from materials such as chrome, quartz or a suitable dielectric material, and it will be appreciated that different masks may be used to impart different orientation patterns to the photo-orientatable polymeric layer 2.

Referring to FIG. 2, there is shown an optical component 20 which may be formed using the method and apparatus illustrated schematically in FIG. 1. The optical component 20 comprises a layer of a photo polymeric network (PPN) applied to one side of a substrate 23 and a liquid crystal polymer (LCP) layer 26 applied over the PPN layer 22. In a preferred method of manufacturing the optical component of 20, a solution containing a photo-orientatable polymer network is applied to the substrate 23. The substrate is then dried and the PPN solvent removed. The PPN layer 22 is preferably applied to a thickness of between about 2 nm and about 150 nm.

The PPN layer 26 is then subjected to exposure of the first polarised laser beam 14 using the apparatus of FIG. 1 to orientate and polymerise the molecules in first areas 24 of the PPN layer 22. After the predetermined delay time, which is preferably at least about 20 nanoseconds, the second beam 50 of linearly polarised light arrives at the PPN layer 22 to orientate and polymerise the molecules in the second areas 25 of the PPN layer 22 so that those areas 25 have a second molecular orientation which is different from that of the first areas 24 to form the orientation 25 pattern in the PPN layer 22.

A solution containing liquid crystal monomers is then applied over the PPN layer 22 the liquid crystal molecules assume the orientation of the underlying PPN layer 22. The solvent is then removed and the liquid crystal monomers are photo cross-linked by an exposure to light of a suitable wave length to form the LCP layer 26. The photo-cross-linking process fixes the orientation of the LCP layer 26 so that it has first areas 27 having the same orientation as the first areas 24 of PPN layer 22, and second areas 28 having the same molecular orientation as the molecules in the second areas 25 of the PPN layer 22.

As shown in FIG. 2, the vertical arrows schematically represent a first molecular orientation in the first areas 24, 27, and the horizontal arrows schematically represent a second molecular orientation in the second areas 25, 28. It should, however, be appreciated that the molecular orientation represented by both sets of arrows will be in the plane of the layers 22, 26 rather than normal to the surface of the layers.

The optical component 20 of FIG. 2 may be attached to any article to provide a means of verifying that the article is authentic, but is particularly suitable for use as a security device in security documents and tokens which require protection against copying and counterfeiting. When the security device 20 is to be attached to another article, the PPN layer 22 and the LCP layer 26 preferably cover the entire surface of the substrate 23. Alternatively, the PPN and LCP layers 22 and 26 may only partially cover the surface of the substrate, for instance when the substrate 23 itself constitutes the base layer for a security document or token.

Referring to FIG. 3, there is shown a modified optical component 30 which is similar to that of FIG. 2 and corresponding reference numerals have been applied to corresponding parts. The security device 30 differs from that of FIG. 2 in that it includes an orientating layer 32 on the substrate and an LCP layer 6 provided between the substrate and the photo-orientated polymer network (PPN) layer 22 and LCP layer 26. The orientating layer 32 may have a uniform orientation pattern, e.g. produced by subjecting a photo-orientatable polymer network (PPN) layer to a single exposure of linearly polarised light without a mask, or it may be a conventional orientating layer such as a polyimide layer rubbed in one direction or a layer having an orientating effect obtained by oblique sputtering with SiOₓ. Alternatively, the orientating layer 32 may be a PPN layer having an orientation pattern of different areas having different molecular orientations formed in the manner described with reference to FIG. 1. The LCP layer 36 preferably comprises an isotropic layer of orientated cross-linked liquid crystal monomers which has an orientation determined by the underlying orientating layer 32. The orientation of the liquid crystal molecules in layer 36 may be fixed by a photo cross-linking process, such as described above with reference to FIG. 2.

FIG. 4 shows another modified optical component 40 which is similar to that of FIG. 2 and corresponding reference numerals have been applied to corresponding parts. The optical component 40 differs from that of FIG. 2 in that it includes a linear polariser 41 between the substrate 23 and the photo-orientated polymer network (PPN) layer 22. The inclusion of a linear polariser 41 underneath the PPN layer 22 enables the optical effects produced by the LCP layer 26 and PPN layer 22 to be viewed using a single polariser, instead of requiring cross-polarisers to view the effects. In an alternative embodiment, a reflective metal layer may replace the polarising layer 41.

In another modified embodiment similar to that of FIG. 4, when the substrate 23 is formed from or includes a polymeric layer, such as a transparent polymeric film used in the manufacture of flexible security documents, a primer layer may be provided between the substrate 23 and the PPN layer 22 to improve the adhesion of the PPN layer to the substrate. The primer layer may comprise a hydroxyl terminated polyester based co-polymer with a cross-linker such as a multi-functional isocyanate as described in our co-pending Australian patent application entitled “Security Document Incorporating Optical Components” filed on 12 Jan. 2004. It will, however, be appreciated that other primers and cross-linkers may be used to form the primer layer.

Referring to FIG. 5, the beam splitting and beam directing parts of the apparatus of FIG. 1 are shown in greater detail. As shown in FIG. 5, the incident beam 12 from the laser source 11 is split into the first and second polarised beams 14 and 15 by the polarising beam splitter 13. The first polarised beam 14 passes directly through the apparatus to the mask (not shown in FIG. 5) which directs the first beam on to selected areas of the photo-orientatable polymer layer 2. The second polarised beam 15 is reflected off a first mirror 52 through a triangular shaped container which includes a plurality of time of flight mirrors 16. The time of flight mirrors delay the second beam by the predetermined delay time which is preferably at least 20 nanoseconds. The second beam 15 is then reflected off reflecting mirror 17 through an aperture 56 and onto mirrors 18 and 19. The second beam 15 reflected off mirror 19 then passes through a polarisation rotator 51 and an attenuator 53 and is directed out of the apparatus and on to the photo-orientatable polymeric layer 2 of the optical component 1 as illustrated in FIG. 1.

As shown in FIG. 5, the second beam may also be directed on to a beam splitter 60 to produce an optional third beam of linearly polarised light 62. The third beam 62 also passes through a polarisation rotator 61 and an attenuator 63 and may be used to form third areas having a third molecular orientation in the PPN layer 2. The polarisation rotators 51, 61 allow for design changes to be made to the polarisation pattern formed in the PPN layer 2 by the respective first, second and optional third beams. The attenuators 53, 63 provide energy control for the second and third beams. Preferably the ratio of energy in the first linearly polarised beam 14 is approximately twice that of the second linearly polarised beam 15 and the optional third polarised beam 62.

The apparatus of FIG. 5 also includes a diode laser 64 which passes through a cylindrical lens 66 and an adjustment mirror (Ma) which is used to align the direction of the second beam 15 and optional third beam 62.

It will be appreciated that the method and apparatus described above provides for manufacture of an optical component in which a second exposure of a photo-orientatable polymeric layer to a second beam of linearly polarised light occurs very shortly after a first exposure of selected areas of the photo polymeric layer to a first beam of linearly polarised light through a mask. This is a more efficient process for manufacturing an optical component incorporating a photo-polymeric layer than multiple exposure processes in which the photo-orientatable polymeric layer is subjected to selected exposure to a first beam of linearly polarised light through a mask, and subsequently to a second exposure to a second beam of linearly polarised light after removal of the mask. The apparatus and method of the present invention therefore enables optical components having at least one photo-oriented polymeric layer to be produced more economically.

It will be appreciated that various modifications may be made to the preferred embodiments described above without departing from the scope and spirit of the present invention.

For instance, the photo-oriented polymeric network (PPN) layer 2 or 22 may also include areas of randomly oriented molecules in addition to the first areas having a first molecular alignment or orientation and the second areas having a second molecular alignment or orientation.

1. A method of manufacturing an optical component having at least one photo-oriented polymeric layer provided on a substrate, wherein the method includes the steps of:
providing a single source of laser radiation;
splitting the laser radiation into a first beam of linearly polarized light having a first plane of polarization, and a second beam of linearly polarized light having a second plane of polarization;
directing the first beam of linearly polarized light onto a first area or areas of at least one photo-orientatable polymeric layer to cause a first molecular orientation in the first area or areas of the layer; and
directing the second beam of linearly polarized light onto said photo-orientatable polymeric layer to cause a second molecular orientation in a second area or areas of the layer.

2. A method according to claim 1 wherein the arrangement is such that the second beam of linearly polarized light arrives at the photo-orientatable polymeric layer a predetermined delay time after the first beam of linearly polarized light.

3. A method according to claim 2 wherein the predetermined delay time is sufficient for the first beam to have caused the first molecular orientation in the first area or areas of the photo-orientatable polymeric layer before the second beam arrives.

4. A method according to claim 2 wherein the predetermined delay time is in the order of nanoseconds.

5. (canceled)

6. A method according to claim 1 wherein the first beam is directed onto the first area or areas of the photo-orientable polymeric layer through a mask.

7. A method according to claim 6 wherein the second beam is directed onto the second area or areas of the photo-orientable polymeric layer through a mask.

8. A method according to claim 1 wherein the second beam is directed onto the entire area of the photo-orientatable polymeric layer including the first and second areas.

9. A method according to claim 1 wherein the energy of each of the first and second beams is less than the energy required to cause laser ablation of the photo-orientatable polymeric layer.

10. A method according to claim 1 wherein the ratio of the energy of the first beam to the energy of the second beam is approximately 2:1 energy units.

11-25. (canceled)

26. A method according to claim 1 wherein the energy of each of the first and second beams is less than the cohesive/adhesive forces adhering the photo-orientatable layer to the substrate.

27. An apparatus for manufacturing an optical component having at least one photo-oriented polymeric layer, wherein the apparatus comprises:
a single source of laser radiation;
beam splitting means for splitting the laser radiation into a first beam of linearly polarized light having a first plane of polarisation and a second beam of linearly polarized light having a second plane of polarization;
first directing means for directing the first beam of linearly polarized light onto a first area or areas of at least one photo-orientatable polymeric layer to cause a first molecular orientation in said first area or areas of the layer; and
second directing means for directing the second beam of linearly polarized light onto said at least one photo-orientatable polymeric layer to cause a second molecular orientation in a second area or areas of the layer;
wherein the apparatus includes delay means for the second beam of linearly polarized light so that the second beam arrives at the photo-orientatable layer a predetermined delay time after the first beam of linearly polarized light.

28. An apparatus according to claim 27 wherein the second beam of linearly polarized light is reflected off a plurality of mirrors before it is directed onto the photo-orientatable polymeric layer.

29. An apparatus according to claim 27 wherein the first beam of linearly polarized light is directed onto the photo-orientatable layer through a mask so that only the first area or areas of the photo-orientatable polymeric layer are exposed to the first beam.

30. An apparatus according to claim 27 wherein the second beam of linearly polarized light is directed onto the second area or areas through a mask.

31. An apparatus according to claim 29 wherein the mask is formed from any one of the following:
chrome; or
quartz; or
a dielectric material.

32. An apparatus according to claim 27 the second beam is directed onto the entire area of the photo-orientatable polymeric layer including the first and second areas.

33. An apparatus according to claim 27 further including a second beam splitting means for splitting the second beam into a third beam having a third plane of polarization.

34. An apparatus according to claim 33 further including third directing means for directing the third beam of linearly polarized light onto said photo-orientatable polymeric layer to cause a third molecular orientation in a third area or areas.

35. An apparatus according to claim 27 further including at least one polarization rotator.

36. An apparatus according to claim 27 further including an attenuator to provide energy control for the second beam.

37. An apparatus according to claim 27 further including a diode laser, a cylindrical lens and an adjustment mirror for aligning the direction of the second beam.

38. An optical component which incorporates at least one photo-oriented polymeric layer formed by the method of claim 1.

39. (canceled)

40. A security document or device including an optical component formed by the method of claim 1.

41. (canceled)
